(19) United States
(12) Patent Application Publication
(10) Pub. No.: US 2004/0231612 A1
(43) Pub. Date: Nov. 25, 2004

(54) Feather assembly for preventing birds from flying into windows and associated method of use

(75) Inventors: William H. Thompson III, Whipple, OH (US); Stiles Thomas, Allendale, NJ (US)

Correspondence Address: WOOD, HERRON & EVANS, LLP, 2700 CAREW TOWER, 441 VINE STREET, CINCINNATI, OH, 45202, US

(73) Assignee: Indigo Hill, LLC, Whipple, OH

(21) Appl. No.: 10/840,013

(22) Filed: May 6, 2004

Related U.S. Application Data
(60) Provisional application No. 60/468,441, filed on May 6, 2003.

(51) Int. Cl. A22C 18/00

(52) U.S. Cl. 119/713

(57) ABSTRACT

A feather assembly prevents birds from flying into a glass window or door. The feather assembly comprises a length of line and a plurality of brightly colored feathers secured to the line at spaced locations. The feather assembly is secured over a glass window or door such that it sways from one side of the glass to the other in the wind. The bright colors, motion and birds' natural aversion to loose feathers scare wilds birds away from windows or doors.

This claims the benefit of U.S. Provisional Patent Application Ser. No. 60/468,441, filed May 6, 2004 and hereby incorporated by reference in its entirety.

### FIELD OF THE INVENTION

The invention generally relates to a feather assembly for preventing birds from flying into windows and similar structures and to a method of using the assembly.

### BACKGROUND OF THE INVENTION

As many as 975 million birds are estimated to be killed in the United States each year in collisions with glass windows and glass buildings. Songbirds such as American robins, northern cardinals, purple finches, dark-eyed jinkos, and cedar waxwings are among the most numerous victims of such accidents. The glass causes a reflection of the sky and habitat around the bird, thereby creating a deadly optical illusion. Flying birds are unable to discern between these reflections and their natural environment. Consequently, birds collide with such windows or structures at full speed, often causing serious damage to the bird and/or the structure and, quite often, death to the unknowing bird.

Various techniques and devices have been developed in an attempt to prevent such deadly collisions. Silhouettes of flying hawks or falcons have been developed and placed on the glass windows of homes and other buildings in an attempt to scare away songbirds. Other objects such as shiny metal strips and netting have been developed to be placed over windows, but such devices are often unsightly and ineffective. Hanging objects such as wind chimes, wind socks or potted plants placed in front of windows may help prevent the birds from flying into a window. However, such preventative measures reduce visibility through the window and are often not effective.

Consequently, there is a need for a device which does not affect visibility through the window and which is effective in preventing birds from colliding with windows and similar structures.

### SUMMARY OF THE INVENTION

This invention addresses these and other problems associated with the prior art by providing a feather assembly comprising a length of line or string and a plurality of brightly colored feathers secured to the line at spaced locations along the length of the line.

The line is preferably made of nylon monofilament, the same material as fishing line: However, the line may be made of any suitable material. Preferably, the line is 5 to 10 feet in length. However, the line may be any length, depending on the size of the window or structure to be protected or marked.

A plurality of brightly colored feathers are secured to the line at spaced locations along the line. One preferred method of securing the feathers to the line at fixed locations is to drill holes in the shafts of the feathers and tie knots in the line on both sides of the feather shaft after the line is passed through the feather shaft. Any other method may be used to fix the location of the feather along the length of the line. Preferably, the feathers are 6 to 8 inches apart along the length of line. However, the feathers may be secured to the length of line at any desired distance from each other.

For the feather assembly of this invention to function properly, it should preferably be able to move or sway in the wind once secured outside a window. In nature, wild birds instinctively know that loose feathers blowing in the wind are often a sign that another bird has been killed by a predator in the vicinity. A wild bird knows that loose blowing feathers mean danger and consequently, the wild bird moves away from the danger.

One suitable method of installing the feather assembly of this invention in place is to secure a first nail or other suitable fastener to a window frame above the window and secure a second fastener to the window frame below the window. The ends of the line of the feather assembly are then secured to these fasteners with knots or any other suitable method. Although the use of fasteners is one preferred method of securing the feather assembly in place so that it is able to blow in the wind, any other method of securing the feather assembly in place may be used without departing from the spirit of the invention. Other methods using suction cups, duct tape, staples or magnets may be used to secure the ends of the line to the outside of the window, window frame, sliding glass door, reflective structure or building exterior.

The combination of brightly colored feathers which are capable of catching the attention of wild birds, the motion imparted to the feathers by the wind and the natural aversion of wild birds to loose feathers all contribute to make this invention effective in preventing wild birds from flying into windows.

These and other advantages and features, which characterize the invention, are set forth in the claims annexed hereto and forming a further part hereof. However, for a better understanding of the invention, and of the advantages and objectives attained through its use, reference should be made to the drawings and to the accompanying descriptive matter in which this invention is described.

### BRIEF DESCRIPTION OF THE DRAWING

The objectives and features of the invention will become more readily apparent from the following detailed description taken in conjunction with the accompanying drawings in which:

FIG. 1 is a perspective view of one preferred embodiment of the feather assembly of this invention; and

FIG. 2 is a perspective view of two feather assemblies of this invention secured in place outside windows of a building.

### DETAILED DESCRIPTION OF THE DRAWING

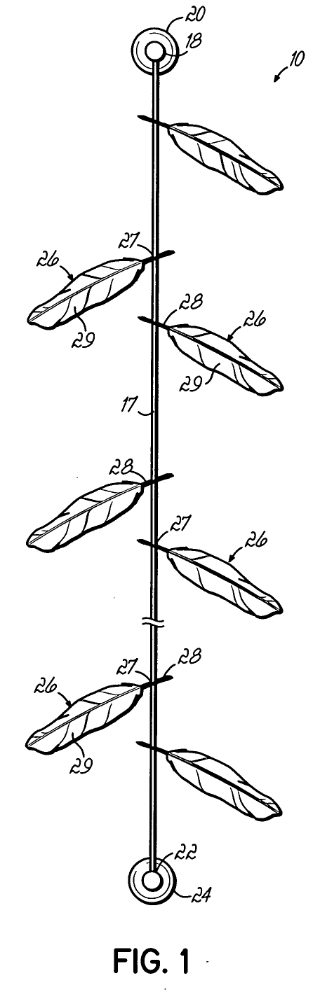

Referring to the drawings and particularly FIG. 1, a feather assembly 10 used to reduce bird/glass collisions is illustrated. The feather assembly 10 is intended to replicate feathers from a wounded or killed bird and thereby scare healthy wild birds 12 away from glass windows or doors.

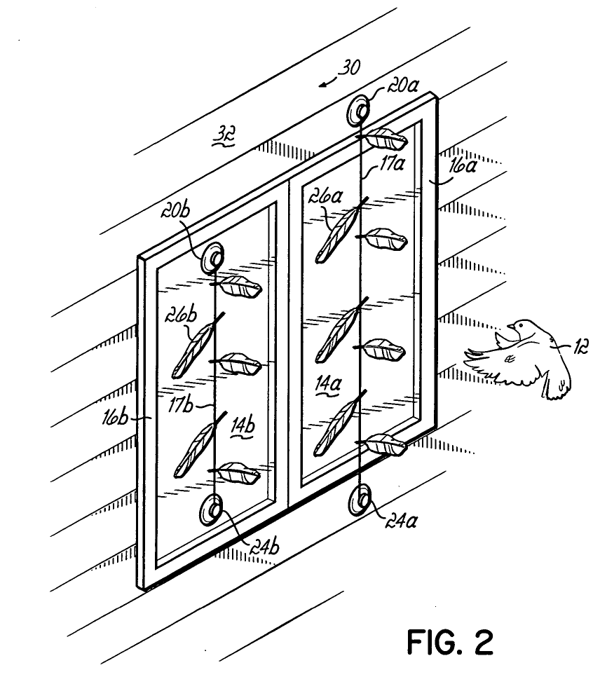

FIG. 2 illustrates two feather assemblies 10a, 10b used to prevent birds 12 from flying into glass windows 14a, 14b. Windows 14a, 14b are surrounded by window frames 16a, 16b. Although FIG. 2 illustrates two feather assemblies 10a, 10b of the present invention being used in connection with one type of window, the present invention may be used on any type of glass window or door, for example a sliding glass door or window without a frame or other reflective structure.

Referring to FIG. 1, the feather assembly 10 comprises a length of flexible line 17 which preferably is made of nylon monofilament, but may be made of any suitable material. The length of line 17 has a first end 18 secured to a first anchor 20 and a second end 22 secured to a second anchor 24. The first and second ends 18, 22 of the length of line 17 may be secured in any desired fashion to the anchors 20, 24. Although the anchors 20, 24 are illustrated as being suction cups, they may be any other structure such as magnets, for example. If desired, the anchors may be omitted entirely as described below.

In one preferred embodiment of the present invention, the length of line 17 is between 5 and 10 feet. However, the length of line 17 of the feather assembly 10 may be any desired length.

Referring to FIG. 1, a plurality of brightly colored feathers 26 are secured to the length of line 17 at spaced locations along the length of line 17. More specifically, each of the feathers 26 has a shaft 28 from which feathering 29 extends outwardly. The length of line 17 is preferably secured to the shaft 28 of each of the feathers 26 but may be secured to other portions of the feathers 26. In one preferred embodiment, a hole 27 is drilled in the feather shaft 28, through which the length of line 17 passes. The length of line 17 is knotted above and below the feather shafts 28 to fix the location of the feather 26 relative to the length of line 17 so the feathers 26 do not slide or move along the length of line 17.

The feathers 26 are preferably artificially colored to impart bright colors to the feathers. However, natural feathers, preferably having bright colors, may be used in accordance with this invention. For example, and without limitation, the colors of the feathers are preferably red, yellow, blue, green, orange, pink, purple or the like. In one embodiment of the invention, the colors of the feathers are coordinated to correspond to a particular decor, seasonal decoration, or favorite color scheme, such as a sports team (i.e., blue and orange for the Denver Broncos during football season) or the like. The term “feathers” for purposes of this application is not intended to be limited to natural feathers; any similar items may be used. The feathers are preferably spaced from one another every 6-8 inches but may be spaced from each other at any other predetermined distance. Each feather is preferably between 4 and 8 inches in length. However, any size of feather may be used in accordance with the present invention.

As shown in FIG. 2, the window frames 16a, 16b in which are located windows 14a, 14b are secured in the exterior of a building 30 covered with siding 32. The building 30 may be a residential dwelling, an office building or other building. A feather assembly 10a, like the feather assembly 10 shown in FIG. 1, is secured to the siding 32 of building 30 using anchors 20a, 24a in the form of suction cups. The feather assembly 10a comprises a length of line 17a to which are secured a plurality of brightly colored feathers 26a in the manner described above. Anchor 20a is secured to the siding 32 of the building 30 generally above the window frame 16a and anchor 24a is secured to the siding 32 on the exterior of the building 30 generally below the window 16. Although anchors 20a, 24a are illustrated FIG. 2 as being located in certain locations, the anchors 20a, 24a may be secured to other locations on the building 30, window 14a, 14b or window frame 16a, 16b.

In alternative preferred embodiments of this invention, the anchors 20a, 24a of feather assembly 10a may be omitted. In such embodiments, first and second ends 18a, 22a of the line 17a may be secured directly to the siding 32 of the building 30 or to the window frame 16a with fasteners, duct tape, magnets or any other securement.

While the line 17 is shown relatively taught when the assembly 10 is installed, it may be slack to permit movement of the line 17 and feathers 26 instead of just movement of the feathers 26 relative to the line 17.

Referring again to FIG. 2, a feather assembly 10b, like the feather assembly 10 shown in FIG. 1, is secured to the window 14b using anchors 20a, 24a in the form of suction cups. Suction cups work well for all types of windows and eliminate the need to make holes in the building or window frame wood, siding, or brick. The feather assembly 10b comprises a length of line 17b to which are secured a plurality of brightly colored feathers 26b in the manner described above. Anchor 20b is secured to an upper portion of the window 14a and anchor 24a is secured to a lower portion of the window 14b. Although anchors 20b, 24b are illustrated FIG. 2 as being located in certain locations, the anchors 20b, 24b may be secured to other locations on the window 14b.

In alternative preferred embodiments of this invention, the anchors 20b, 24b of the feather assembly 10b may be omitted. In such embodiments, first and second ends 18b, 22b of the length of line 17b may be secured to the window 14b with fasteners, duct tape, magnets or any other structure.

This invention also encompasses a method of preventing birds from flying into a window using a feather assembly like one of those described above. The method includes providing a feather assembly 10 comprising a length of line 17 to which are secured a plurality of brightly and/or artificially colored feathers 26 as described above. A first end 18 of the length of line 17 is secured above a window, such as window 14a shown in FIG. 2 and a second end 22 of the length of line 17 is secured below the window. The anchor points at the ends of the length of line 17 are selected so that the length of line 17 has slack to enable the feather assembly 10 to sway or move in a breeze, thereby imitating loosely floating feathers of an injured or dead bird. The first and second ends 18, 22 of the length of line 17 may be secured to the window frame with fasteners such as nails or magnets if desired. Alternatively, the first and second ends 18, 22 of the length of line 17 may be secured directly to a building, like building 30 shown FIG. 2, with fasteners, duct tape or anchors like the suction cups 20, 24 shown in FIG. 1. Alternatively, the ends 18, 22 of the length of line 17 may be secured to the window 16 itself in any desired manner including those described above.

The feather assembly and method of the present invention may effectively be used to prevent birds from unnecessarily injury or death by using the inherent instinct of wild birds to stay away from loosely floating feathers.

The invention and use thereof may be appreciated by those skilled in the art to not be limited to the embodiments described and other modifications apparent to those of ordinary skill in the art. For example, the term “feather” and the like as used herein mean any structure resembling a feather; it need not be a natural feather. Therefore, the invention lies in the claims hereinafter appended.

What is claimed is:

1. A feather assembly for preventing birds from flying into a window, said feather assembly comprising:
a length of line; and
a plurality of brightly colored feathers secured to said line at spaced locations.

2. The feather assembly of claim 1 wherein said line is nylon monofilament.

3. The feather assembly of claim 1 wherein said length of line is between 5 and 10 feet.

4. The feather assembly of claim 1 wherein said feathers are spaced from each other approximately 7 inches.

5. The feather assembly of claim 1 wherein each of said feathers is between 4 and 8 inches in length.

6. The feather assembly of claim 1 wherein the feathers are artificially colored.

7. A feather assembly for preventing birds from flying into a window, said feather assembly comprising:
a length of flexible line;
a pair of anchors secured to opposite ends of said length of line, each of said anchors adapted to be secured to a structure proximate the window; and
a plurality of brightly colored feathers secured to said line at spaced locations, each of said feathers having a shaft to which said line is secured.

8. The feather assembly of claim 7 wherein said anchors are suction cups.

9. The feather assembly of claim 7 wherein said feathers are artificially colored.

10. The feather assembly of claim 7 wherein said line is nylon monofilament.

11. The feather assembly of claim 7 wherein said length of line is between 5 and 10 feet.

12. The feather assembly of claim 7 wherein said feathers are spaced from each other an identical distance.

13. The feather assembly of claim 7 wherein each of said feathers is between 4 and 8 inches in length.

14. A method of preventing birds from flying into a window, said method comprising:
providing a feather assembly comprising a length of line and a plurality of brightly colored feathers secured to said line at spaced locations; and
securing one end of said length of line above said window and the other end of said line below said window.

15. The method of claim 14 wherein securing said one end of said length of line above said window and the other end of said line below said window comprises securing anchors above and below said window and securing opposite ends of said length of line to said anchors.

16. The method of claim 14 wherein said securing step results in said length of line having slack to enable said feathers to sway in a breeze.

17. A method of preventing birds from flying into a window, said method comprising:
providing a feather assembly comprising a length of line, anchors secured to opposite ends of said length of line and a plurality of brightly colored feathers secured to said line at spaced locations; and
securing said anchors to a window such that said length of line has slack to enable said feathers to sway in a breeze.

18. A method of preventing birds from flying into a window, said method comprising:
providing a feather assembly comprising a length of line and a plurality of feathers secured to said line at spaced locations;
securing anchors to a window; and
securing opposite ends of said length of line to said anchors such that said length of line has slack to enable said feathers to sway in a breeze.

19. A method of preventing birds from flying into a window, said method comprising:
providing a feather assembly comprising a length of line and a plurality of feathers secured to said line at spaced locations;
securing anchors above and below a window; and
securing opposite ends of said length of line to said anchors such that said length of line has slack to enable said feathers to sway in a breeze.
